(19) United States
(12) Patent Application Publication
(10) Pub. No.: US 2013/0189700 A1
(43) Pub. Date: Jul. 25, 2013

(54) BREAKAGE OF AN EMULSION CONTAINING NUCLEIC ACID

(71) Applicants: Austin P. So, Pleasanton, CA (US); Svilen S. Tzonev, Pleasanton, CA (US); Serge Saxonov, Oakland, CA (US); Benjamin J. Hindson, Livermore, CA (US); Michael Y. Lucero, South San Francisco, CA (US)

(72) Inventors: Austin P. So, Pleasanton, CA (US); Svilen S. Tzonev, Pleasanton, CA (US); Serge Saxonov, Oakland, CA (US); Benjamin J. Hindson, Livermore, CA (US); Michael Y. Lucero, South San Francisco, CA (US)

(73) Assignee: BIO-RAD LABORATORIES, INC., Hercules, CA (US)

(21) Appl. No.: 13/558,260

(22) Filed: Jul. 25, 2012

Related U.S. Application Data
(60) Provisional application No. 61/511,445, filed on Jul. 25, 2011.

(51) Int. Cl. G01N 1/34

(52) U.S. Cl. CPC G01N 1/34
USPC 435/6.12; 536/25.41

(57) ABSTRACT

Methods of processing an emulsion of aqueous droplets containing nucleic acid. The methods may include breakage of the emulsion with a destabilizing fluid including a halogen-substituted hydrocarbon.

### CROSS-REFERENCE TO PRIORITY APPLICATION

This application is based upon and claims the benefit under 35 U.S.C. §119(e) of U.S. Provisional Patent Application Ser. No. 61/511,445, filed Jul. 25, 2011, which is incorporated herein by reference in its entirety for all purposes.

### CROSS-REFERENCES TO OTHER MATERIALS

This application incorporates by reference in their entireties for all purposes the following materials: U.S. Pat. No. 7,041,481, issued May 9, 2006; U.S. Patent Application Publication No. 2010/0173394 A1, published Jul. 8, 2010; U.S. Patent Application Publication No. 2011/0217712 A1, published Sep. 8, 2011; U.S. Provisional Patent Application Ser. No. 61/601,514, filed Feb. 21, 2012; and Joseph R. Lakowicz, PRINCIPLES OF FLUORESCENCE SPECTROSCOPY (2^{nd} Ed. 1999).

### INTRODUCTION

Aqueous droplets can be suspended in oil to create a water-in-oil emulsion. The emulsion can be stabilized with a surfactant, to reduce coalescence of droplets during heating, cooling, and transport, thereby enabling thermal cycling to be performed. Accordingly, emulsions have been used to perform single-copy amplification of nucleic acid templates in droplets using the polymerase chain reaction (PCR).

Compartmentalization of single templates in droplets of an emulsion alleviates problems encountered in amplification of complex mixtures of templates together in a bulk phase. In particular, droplets can promote more efficient and uniform amplification of templates from samples containing complex heterogeneous nucleic acid populations, because sample complexity in each droplet is reduced. The impact of factors that lead to biasing in bulk amplification, such as amplification efficiency, G+C content, and amplicon annealing, can be minimized by compartmentalization in droplets. Unbiased amplification can be critical in detection of rare species, such as pathogens or cancer cells, the presence of which could be masked by a high concentration of background species in complex clinical samples. Massively parallel approaches to sequencing also utilize compartmentalized amplification of single templates in droplets to avoid bias.

A stabilized emulsion can withstand the repetitive cycles of heating and cooling that drive PCR amplification, without complete loss of droplet integrity. However, it is often desirable to harvest nucleic acid from the emulsion after amplification for further analysis, such as by sequencing. In this case, the emulsion needs to be destabilized or “broken,” to coalesce the dispersed aqueous phase into a continuous aqueous phase for access to the amplified nucleic acid. Emulsions that are stable enough to retain their integrity during PCR amplification can be difficult to break.

Approaches are needed to break emulsions containing nucleic acid for further reaction, selection, and/or analysis of the nucleic acid.

### SUMMARY

The present disclosure provides methods of processing an emulsion of aqueous droplets containing nucleic acid. The methods may include breakage of the emulsion with a destabilizing fluid including a halogen-substituted hydrocarbon.

### BRIEF DESCRIPTION OF THE DRAWINGS

FIG. 1 is a flow diagram of an exemplary method of processing an emulsion of aqueous droplets containing nucleic acid, where the method includes breaking the emulsion with a destabilizing fluid, in accordance with aspects of the present disclosure.

FIG. 2 is a schematic view of an exemplary droplet from an emulsion to be broken, in accordance with aspects of the present disclosure.

FIG. 3 is a flow diagram of an exemplary method of processing an emulsion of aqueous droplets containing nucleic acid connected to beads, where the method includes breaking the emulsion with a destabilizing fluid, in accordance with aspects of the present disclosure.

### DETAILED DESCRIPTION

The present disclosure provides methods of processing an emulsion of aqueous droplets containing nucleic acid. The methods may include breakage of the emulsion with a destabilizing fluid including a halogen-substituted hydrocarbon.

An exemplary method is provided. In the method, an emulsion of aqueous droplets containing nucleic acid is provided. The emulsion may be mixed with of an amount of destabilizing fluid effective to break the emulsion. The destabilizing fluid may include a halogen-substituted hydrocarbon. The nucleic acid may be isolated after mixing

Another exemplary method of processing an emulsion is provided. In the method, an emulsion of aqueous droplets containing nucleic acid is provided. The emulsion may be mixed with of an amount of chloroform effective to induce coalescence of the droplets. The emulsion mixed with chloroform may be centrifuged.

Yet another exemplary method of processing an emulsion is provided. In the method, an emulsion of aqueous droplets containing nucleic acid connected to beads is provided. The emulsion may be mixed with of an amount of chloroform effective to break the emulsion.

The emulsion may be generated in a stabilized form, such as in the presence of surfactant and/or protein, to at least substantially maintain the integrity of aqueous droplets during droplet manipulation and/or performance of a reaction (e.g., nucleic amplification through thermal cycling). The destabilizing fluid destabilizes the droplets of the emulsion, such as by removal or disruption of a proteinaceous skin and/or surfactant layer that surrounds each droplet. As a result, the droplets fuse to form a continuous aqueous phase, which may be separated from the destabilizing fluid and/or the carrier phase of the emulsion. Nucleic acid from the continuous aqueous phase then may be combined with one or more other reagents to perform another reaction(s) (e.g., sequencing), may be resolved into different components (e.g., by size), may be disposed in droplets again (e.g., to perform a serial enrichment/selection process), and/or may be detected with a detector, among others.

The methods of processing emulsions disclosed herein may have numerous advantages over other approaches, such as increased speed, more efficient recovery of droplet components, better breakage of stabilized emulsions, and/or reduced cost, among others.

Further aspects of the present disclosure are presented in the following sections: (I) overview of exemplary methods, and (II) examples.

### I. OVERVIEW OF EXEMPLARY METHODS

This section provides an overview of exemplary methods of processing an emulsion of aqueous droplets containing nucleic acid, where processing includes breakage of the emulsion with a destabilizing fluid. Breakage of the emulsion produces coalescence of a majority of the droplets, generally at least substantially all of the droplets. The method steps disclosed in this section and elsewhere in the present disclosure may be performed in any suitable combination, in any suitable order, and each may be omitted or performed any suitable number of times.

An emulsion may be generated. The emulsion may include aqueous droplets disposed in an immiscible carrier phase. Droplets of the emulsion may be generated serially with one or more droplet generators (e.g., a structure providing at least one orifice at which droplets form), or in bulk (e.g., by vigorous mixing of prospective emulsion phases), among others. The droplets may be uniform (monodisperse) or variable (polydisperse) in size.

Each aqueous droplet may provide a microreactor in which to perform a reaction, such as nucleic acid amplification. In other words, each droplet may be configured to amplify a nucleic acid template, if present, in the droplet. In other cases, the reaction may include transcription, translation, ligation, methylation, hydrolysis, degradation (e.g., digestion), binding (e.g., binding of receptor to ligand, substrate to enzyme, etc.). The aqueous droplets may be stabilized against coalescence (fusion) by the presence of one or more surfactants and/or proteins in the carrier phase and/or dispersed aqueous phase of the emulsion. In some embodiments, each droplet may be encapsulated individually by a skin, which may be a proteinaceous skin, disposed at the interface between the droplet and the carrier phase. Further aspects of forming a skin to encapsulate droplets are described in U.S. Patent Application Publication No. 2011/0217712 A1, published Sep. 8, 2011, which is incorporated herein by reference.

The carrier phase, which may be described as a continuous phase or carrier fluid, may be any suitable hydrophobic fluid. In exemplary embodiments, the carrier phase includes an oil (e.g., a fluorocarbon oil, a silicone oil, or the like) and at least one surfactant.

The emulsion may be subjected to reaction conditions that promote occurrence of a reaction in the droplets. For example, the emulsion (and/or droplets thereof) may be heated to, or incubated at, one or more elevated temperatures (i.e., above room temperature), which may promote an enzyme reaction, such as nucleic acid amplification in the droplets. In some embodiments, the emulsion may be thermally cycled to promote nucleic acid amplification, such as by a polymerase chain reaction or a ligase chain reaction, among others.

Signals may be detected from droplets of the emulsion. The signals may be detected from a portion of the emulsion that is not contacted with destabilizing fluid (e.g., the portion is removed before contact). Alternatively, the signals may be detected from droplets that are then coalesced by contact/mixing with destabilizing fluid. For example, the droplets may be sorted based on the detected signals, and a sorted population of the droplets may be coalesced. The signals may correspond to whether or not a reaction occurred, or an extent to which a reaction and/or binding occurred. In some cases, the signals may indicate whether nucleic acid amplification occurred in particular droplets. In many cases, the emulsion may be broken without detecting signals from the droplets.

The detected signals may be generated from the droplets based on light detected from the droplets. Light may be detected from individual droplets, such as detected in parallel with droplets disposed in a monolayer, or detected serially with droplets disposed in a flow channel, among others

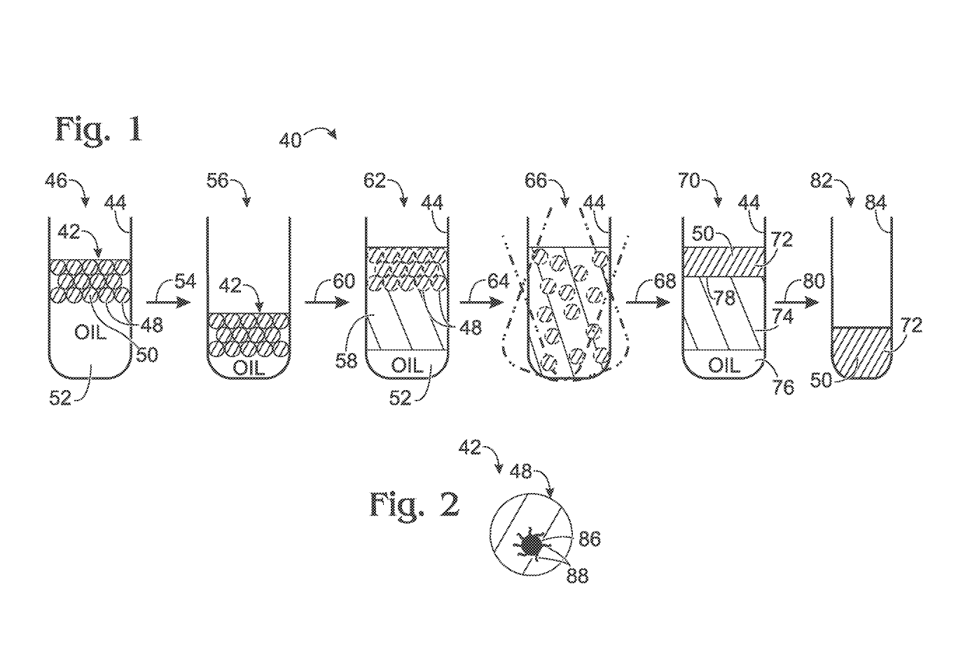

FIG. 1 shows configurations produced during performance of an exemplary method 40 of processing an emulsion 42. The emulsion may be disposed in at least one container 44 during performance of the method, with the container optionally being sealable.

Configuration 46 shows emulsion 42 before breakage. The emulsion may be composed of aqueous droplets 48 containing nucleic acid 50, which may be nucleic acid that was amplified in the droplets (also termed amplicons). The amplified nucleic acid may, for example, be a library of amplicons generated clonally in individual droplets. In other words, each droplet may contain a clonal population of amplicon molecules, with a plurality of different clonal populations contained collectively by the droplets. For example, the library may be generated by clonal amplification, in droplets, of more than 10, 100, or 1000 different types of templates, among others.

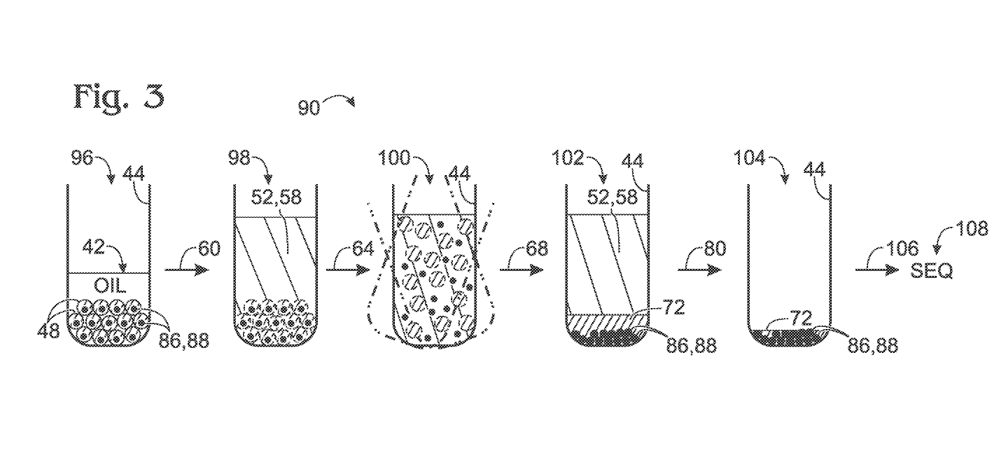

Droplets 48 are disposed in a carrier fluid or carrier phase 52, such as oil. (The droplets are depicted schematically in FIG. 1, and are not drawn to scale.) The droplets may be formed by a dispersed aqueous phase which may have any suitable density relative to the carrier fluid. For example, in the depicted embodiment, the aqueous phase is less dense than the carrier fluid, such that the droplets are buoyant in the carrier fluid. In other embodiments (e.g., see FIG. 3), the aqueous phase may be more dense than the carrier fluid, such that the droplets sink in the carrier fluid. In other examples, the droplets may be dispersed throughout the carrier fluid.

The droplets may represent any suitable volume fraction of the emulsion. For example, in configuration 46, the droplets form less than one-half of the total emulsion volume. As a result, carrier fluid that is substantially droplet free may be present in the emulsion, in this case, at the bottom of the emulsion.

A volume of carrier fluid 52 may be removed from the emulsion, indicated by an arrow at 54, to generate configuration 56. Removal may be conducted by withdrawing carrier fluid, selectively relative to droplets, from container 44. Alternatively, or in addition, removal may be conducted by transferring a droplet-enriched portion of the emulsion to another container. In any event, the volume fraction occupied by the droplets in the emulsion may be increased, and the volume of carrier fluid in the emulsion decreased. Decreasing the volume of carrier fluid may reduce the amount of destabilizing fluid that is effective to break the emulsion, and/or may improve the resolution of phases from one another, among others.

Contact may be created between emulsion 42 and an effective amount of destabilizing fluid 58, indicated by an arrow at 60, to generate configuration 62. For example, the destabilizing fluid may be added to the emulsion in container 44, or the emulsion may be added to the effective amount of destabilizing fluid in another container. Contact between the emulsion and the destabilizing fluid, before substantial mixing, may (or may not) tend to destabilize droplets 48, as indicated by a dashed perimeter for each droplet.

The destabilizing fluid generally can be any fluid that induces droplets of the emulsion to coalesce with one another. The destabilizing fluid may be present at an amount effective to induce coalescence, which may be selected based, for example, on the volume of the emulsion, the volume of carrier fluid in the emulsion, and/or the total volume of droplets, among others. The amount also or alternatively may be selected, based, for example, on the type of carrier fluid, amount and type of surfactant in each phase, etc. In exemplary embodiments, the destabilizing fluid is added to the emulsion, or vice versa, such that the destabilizing fluid is present in excess over the carrier fluid of the emulsion. The ratio of destabilizing fluid to carrier fluid, by volume, may be at least about 1, 2, 3, 4, or 5, among others.

The destabilizing fluid may be immiscible and/or substantially insoluble (e.g., less than about 5, 2, or 1% soluble) or miscible with the aqueous phase of the droplets and miscible or immiscible with the carrier fluid of the emulsion. For example, in the depicted embodiment (configuration 62), destabilizing fluid 58 forms a new phase that is immiscible with the aqueous phase of droplets 48 and immiscible with carrier fluid 52. Destabilizing fluid 58 may be less dense or denser than carrier fluid 52, and less dense or denser than the aqueous phase. In the depicted embodiment, the destabilizing fluid has a density intermediate that of the carrier fluid and the aqueous phase.

The destabilizing fluid may be or include one or more halogen-substituted hydrocarbons. The destabilizing fluid may be predominantly or at least substantially exclusively composed of one or more halogen-substituted hydrocarbons. Each halogen-substituted hydrocarbon may be substituted with one or more halogen substituents provided by the same halogen element (i.e., one or more fluorine, chlorine, bromine, iodine, or astatine substituents) and/or two or more different halogen elements (e.g., at least one fluorine substituent and at least one chlorine substituent, at least one fluorine substituent and at least one bromine substituent, at least one chlorine substituent and at least one bromine substituent, and so on). The halogen-substituted hydrocarbon also optionally may include other non-halogen substituents. In some cases, the halogen-substituted hydrocarbon may have a formula weight of less than about 1000, 500, or 200 daltons, among others. Also or alternatively, the halogen-substituted hydrocarbon may be composed of no more than ten, five, or two carbons. Exemplary halogen-substituted hydrocarbons that may be included in the destabilizing fluid include chloroform, dichloromethane (methylene chloride), iodomethane, bromochloropropane, or dichlorofluoroethane, among others. The destabilizing fluid may have a low viscosity and may be capable of denaturing proteins present in the droplets and/or at an interface between the droplets and the carrier fluid.

The emulsion and destabilizing fluid may be mixed, indicated by an arrow at 64, and illustrated schematically by configuration 66. The emulsion and destabilizing fluid may be mixed to increase the amount of contact between the aqueous phase and the destabilizing fluid. Mixing, which may be vigorous, may be effected by shaking, vortexing, sonicating, stirring, or the like. In some cases, two or more discrete volumes of the organic solvent may be contacted with the emulsion and the step of mixing performed after each instance of contact with a volume of destabilizing fluid. Mixing may be performed with container 44 sealed.

The emulsion mixed with the destabilizing fluid may be centrifuged, indicated by an arrow at 68, to generate configuration 70. Centrifugation may achieve any suitable g-force (e.g., at least about 1,000; 2,000; 5,000; or 10,000 times the force of gravity, among others) for any suitable time period (e.g., at least about 1, 2, 5, 10, 30, or 60 seconds, among others), to promote separation of phases. Centrifugation may promote separation of two or phases (or layers), such as a continuous aqueous phase 72 disposed above, intermediate, or below, one or more phases or layers formed by the carrier fluid and the destabilizing fluid. The carrier fluid and destabilizing fluid may be combined as a single phase or may form respective distinct phases 74, 76. If distinct phases are formed, the carrier fluid may be above or below the destabilizing fluid. Precipitated protein may collect at an interphase region 78 below (or above) the aqueous phase and between the aqueous phase and another phase.

Continuous aqueous phase 72 with nucleic acid 50 may be isolated from the other phase(s), indicated by an arrow at 80, to produce configuration 82. For example, at least a portion of the continuous aqueous phase (or the other phase(s)) may be removed, selectively relative to the other phases, from container 44. The aqueous phase may, for example, be placed in another container 84. In other cases, the other phases may be removed, selectively relative to the aqueous phase, from container 44, to leave the aqueous phase (and/or nucleic acid) selectively in container 44. Removal may be effected by a fluid transfer device, such as a pipet. The non-aqueous phase(s) may be extracted one or more times with additional aqueous fluid to recover more of the continuous aqueous phase and/or nucleic acid therein.

The isolated aqueous phase may be treated to eliminate a small amount of destabilizing fluid and/or carrier fluid that may contaminate the aqueous phase. For example, the aqueous phase may be contacted with a chromatography matrix (e.g., a size-exclusion matrix, an ion-exchange matrix, or the like) to remove residual amounts of unwanted compounds. Alternatively, or in addition, nucleic acid may be further isolated, such as by contact with a chromatography matrix, precipitation of nucleic acid (e.g., with an alcohol), isolation of beads that support the nucleic acid, or the like.

Nucleic acid obtained from the aqueous phase may be processed and/or analyzed. For example, the nucleic acid may be sequenced, sized by chromatography (e.g., by gel electrophoresis), hybridized to a labeled probe, amplified in bulk (with or without error-prone synthesis), ligated, inserted into a vector, disposed in droplets of another emulsion, or any combination thereof, among others.

FIG. 2 shows an exemplary droplet 48 for emulsion 42, with the droplet containing a bead 86 connected to clonal copies of an amplicon 88 generated by amplification in the droplet. The droplet may contain one, two, or more beads. The bead may be a particle for supporting nucleic acid and may have any suitable shape and size, generally a size smaller than the droplet. The amplicon may be a member of a library of different amplicons contained in droplets of the emulsion. Each amplicon may be capable of binding to the same primer. Accordingly, the different amplicons may be sequenced in parallel by extension of and/or ligation to the primer during performance of sequencing reactions with beads isolated from the emulsion. Exemplary sequencing chemistries that may be suitable are described in U.S. Provisional Patent Application Ser. No. 61/601,514, filed Feb. 21, 2012, which is incorporated herein by reference. The amplicon may be connected covalently or noncovalently to the bead (e.g., by base pairing, streptavidin-biotin binding, etc.). In exemplary embodiments, the bead includes a body and at least one type of oligonucleotide (e.g., a primer) connected to the body covalently or noncovalently.

FIG. 3 shows configurations produced during performance of an exemplary method 90 of processing an emulsion 42 having aqueous droplets 48 containing amplified nucleic acid 50 composed of different types of amplicon 88 connected to beads 86. The method steps and configurations illustrated in FIG. 3 generally parallel those in FIG. 1, with exemplary differences described below.

Configuration 96 may be produced by disposing emulsion 42 in a container and/or removing excess carrier fluid from the emulsion, among others (e.g., see FIG. 1). The carrier fluid may be less dense than the droplets, such that the droplets sink to the bottom of the container and excess carrier phase, if any, is disposed above the droplets.

Configuration 98 may be produced by creating contact between destabilizing fluid 58 and the emulsion, indicated by an arrow at 60. Carrier phase 52 and destabilizing fluid 58 may (or may not) be miscible, as illustrated here.

Configuration 100 may be produced by mixing the emulsion with destabilizing fluid, indicated by an arrow at 64.

Configuration 102 may be produced by centrifuging the emulsion mixed with destabilizing fluid, indicated by an arrow at 68. Carrier fluid 52 and destabilizing fluid 58 may be present in the same phase above, as shown here, (or below) the continuous aqueous phase after centrifugation. Based on the relative densities of beads 86, the aqueous phase, and the one or more other fluid phases, the beads may remain in the continuous aqueous phase (as shown here), may move to another phase (e.g., a phase below the aqueous phase and/or a phase at the bottom of the container), or may move to an interphase region at the junction of a pair of phases. Also, if the beads are denser than the fluid phases, the beads may be urged against a surface of the container, generally traveling to a bottom surface region of the container to form a bead pellet, as shown here, which may be visible.

Nucleic acid may be isolated, indicated by an arrow at 80, and represented by configuration 104. For example, beads 86 and their connected nucleic acid 88 may be isolated from the emulsion mixed with destabilizing fluid by removing fluid above the beads, as depicted here. The beads may be washed with a wash solution one or more times (e.g., resuspended in the wash solution and re-pelleted), to further isolate the beads from fluid phases of the emulsion and the destabilizing fluid. In other examples, the beads may be isolated from fluid phases of the emulsion by transferring the beads and associated fluid (e.g., at least a portion of a continuous aqueous phase), selectively relative to other fluid phases, to another container.

The isolated nucleic acid may be sequenced, indicated by an arrow at 106, by performing sequencing reactions to generate sequence data (“SEQ”) indicated by 108. The isolated nucleic acid may be sequenced while connected to the beads or after separation from the beads. The isolated nucleic acid may (or may not) be released from the beads and then disposed in droplets of another emulsion.

Further aspects of generating emulsions, performing nucleic acid amplification in droplets, droplet detection, and processing droplet signals are described in the materials listed above under Cross-References, which are incorporated herein by reference, particularly U.S. Patent Application Publication No. 2010/0173394 A1, published Jul. 8, 2010; and U.S. Patent Application Publication No. 2011/0217712 A1, published Sep. 8, 2011.

### II. EXAMPLES

This section presents selected aspects and embodiments of the present disclosure related to methods of processing an emulsion, where the methods involve emulsion breakage. These aspects and embodiments are intended for illustration only and should not limit the entire scope of the present disclosure.

### Example 1

### Droplet Breakage Protocol

This example describes an exemplary, non-limiting, droplet-breaking protocol. There exists a need to harvest amplification products reliably and efficiently droplets of an emulsion. Physical-based methods typically involve creating mechanical shear forces to rupture the emulsion through multiple freeze-thaw cycles and/or centrifugation. Chemical methods utilized are dependent on the oil that is utilized to create a water-in-oil emulsion, and for silicone-based oils typically involve the use of a variety of organic solvents such as diethyl ether and ethyl acetate to remove the organic phase, coupled with precipitation to recover the desired product. This example describes a method for breaking emulsions created using fluorinated hydrocarbons, in particular those created for PCR through the inclusion of a stabilization reagent.

The following steps may be performed:

A) Following PCR in droplets, transfer droplets to 0.5 ml or 1.5 ml tubes (based on volume of droplets transferred).

B) Add one volume of biotechnology grade chloroform (e.g., Sigma cat no. 288306) and vortex vigorously for 10 seconds.

C) Centrifuge for 10 min at 18,000×g.

D) Carefully remove aqueous layer containing recovered PCR products without disturbing proteinaceous interface.

E) Back-extract the organic phase with 0.5 volumes of Tris-EDTA (TE) buffer and centrifuge as above.

F) Pool recovered aqueous layers and buffer exchange thrice with TE buffer via ultramicrofiltration device (Millipore YM-30, NMWCO=30 kDa) 15 min at 8,000×g to remove contaminating reagents.

G) Assess concentration and purity via UV-VIS spectrophotometry and gel analysis. Approximately 1 μg per 50 μL of droplets may be recovered, with a 260/280 nm ratio of >1.8.

In an exemplary test, a 200 μL volume of emulsion is mixed with an equal volume of chloroform, causing the formation of a flocculate precipitate. Subsequent centrifugation creates a large proteinaceous layer at the interface between the organic and aqueous phases. Vigorous vortexing prior to centrifugation disrupts the flocculate material, resulting in a smaller layer at interface between the organic and aqueous phases, facilitating removal of the aqueous layer.

### Example 2

### Exemplary Utilities for Droplet Breakage

This example describes exemplary strategies that may benefit from use of the droplet breakage procedure disclosed here.

Droplet breakage may be performed after expansion of a diverse population by amplification. The amplification may be substantially unbiased across a diverse population of template species, to preserve representation of each species.

Droplet breakage may be performed after a selection or sorting procedure that enriches members of a nucleic acid population nonuniformly, i.e., in a biased manner. For example, the selection procedure may select for amplicons that amplify more efficiently in the droplets (e.g., that successfully amplify based on primer design criteria versus background/non-specific products). In other cases, the droplets may be sorted based on signals detected from the droplets, and then sorted droplets may be coalesced by emulsion breakage. In yet other cases, the selection procedure may be performed after emulsion breakage, such as by selection for an ability of isolated nucleic acid, and/or a complex including the nucleic acid, to bind to a target.

Nucleic acid may be isolated from monodisperse or polydisperse droplets. Monodisperse droplets may provide more uniform amplification due to the uniformity of compartment/partition size. Also, monodisperse droplets may provide unbiased detection/quantification of products. Polydisperse droplets may contain primer-coated beads that immobilize products. Use of the beads can offset amplification bias resulting from polydispersity, as saturation of primer binding sites over the course of amplification normalizes the amplicon concentration across different beads.

Emulsion breakage may find utility in various applications. Breakage may be suitable for single-cell whole genome amplification for sequencing. High-order multiplexed amplification for sample expansion also may be performed before breakage. Ligands with a desired characteristic can be generated with emulsions using Systematic Evolution of Ligands by Exponential Enrichment (SELEX). Emulsion breakage as disclosed herein can be utilized to isolate nucleic acid from droplets in each round of selection. In other words, nucleic acid can be disposed in an emulsion (and optionally amplified), the emulsion broken, the nucleic acid isolated (and optionally amplified) and then disposed in another emulsion, and so on. Emulsions can be broken during directed evolution/in vitro selection (e.g., for polymerases, nucleases, aptamers, etc.). The emulsions also can be used for amplicon sequencing or targeted resequencing.

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure. Further, ordinal indicators, such as first, second, or third, for identified elements are used to distinguish between the elements, and do not indicate a particular position or order of such elements, unless otherwise specifically stated.

We claim:

1. A method of processing an emulsion, comprising:
providing an emulsion of aqueous droplets containing nucleic acid;
mixing the emulsion with of an amount of destabilizing fluid effective to break the emulsion, the destabilizing fluid including a halogen-substituted hydrocarbon; and
isolating the nucleic acid after mixing.

2. The method of claim 1, wherein the destabilizing fluid includes chloroform.

3. The method of claim 1, wherein the destabilizing fluid is composed at least predominantly of chloroform.

4. The method of claim 1, further comprising a step of performing a sequencing reaction with the isolated nucleic acid.

5. The method of claim 1, wherein the droplets contain amplified nucleic acid connected to beads, and wherein the step of isolating is performed with the amplified nucleic acid connected to the beads.

6. The method of claim 1, wherein the step of isolating nucleic acid includes a step of isolating at least a portion of a continuous aqueous phase formed by coalescence of the droplets containing nucleic acid.

7. The method of claim 1, further comprising a step of centrifuging the emulsion mixed with destabilizing fluid.

8. The method of claim 7, wherein a container holds the emulsion mixed with stabilizing fluid during the step of centrifuging, and wherein the step of isolating includes a step of removing aqueous fluid, selectively relative to beads to which the nucleic acid is connected, from the container after the step of centrifuging.

9. The method of claim 1, further comprising a step of creating contact between the emulsion and the destabilizing fluid, wherein the step of mixing includes a step of vortexing and/or shaking the emulsion and the destabilizing fluid after the step of creating contact.

10. The method of claim 1, wherein the emulsion includes a carrier phase surrounding the droplets, and wherein the amount of destabilizing fluid mixed with the emulsion is an excess by volume relative to the carrier phase.

11. The method of claim 1, wherein the emulsion is a first emulsion, further comprising a step of disposing at least a portion of the isolated nucleic acid in droplets of a second emulsion and then repeating the steps of mixing and isolating.

12. The method of claim 1, wherein the aqueous droplets are encapsulated by a proteinaceous skin.

13. The method of claim 1, further comprising a step of thermally cycling the droplets to amplify nucleic acid in the droplets.

14. The method of claim 1, wherein a continuous aqueous phase is formed after mixing, and wherein the amount of destabilizing fluid is not miscible with the continuous aqueous phase.

15. The method of claim 1, wherein the amount of destabilizing fluid is miscible with a carrier phase of the emulsion.

16. The method of claim 1, further comprising a step of centrifuging the emulsion mixed with destabilizing fluid, wherein after the step of centrifuging a continuous aqueous layer is present above one or more layers formed by a carrier phase of the emulsion and the destabilizing fluid.

17. A method of processing an emulsion, comprising:
providing an emulsion of aqueous droplets containing nucleic acid;
mixing the emulsion with of an amount of chloroform effective to induce coalescence of the droplets; and
centrifuging the emulsion mixed with chloroform.

18. A method of processing an emulsion, comprising:
providing an emulsion of aqueous droplets containing nucleic acid connected to beads; and
mixing the emulsion with of an amount of chloroform effective to break the emulsion.

19. The method of claim 18, further comprising a step of sequencing amplified nucleic acid obtained from the emulsion mixed with chloroform.

20. The method of claim 18, further comprising a step of isolating beads from the emulsion mixed with chloroform.
